(19) United States
(12) Patent Application Publication
(10) Pub. No.: US 2025/0356600 A1
(43) Pub. Date: Nov. 20, 2025

(54) METHOD AND SYSTEM FOR INDICATING REAL AND VIRTUAL OBJECTS

(71) Applicant: Sony Interactive Entertainment Inc., Tokyo (JP)

(72) Inventors: Ryota Murasugi, London (GB); Norihide Kaneko, London (GB); Patrick John Connor, London (GB); Naoise Tobin, London (GB); Graham David Clemo, London (GB)

(21) Appl. No.: 19/205,428

(22) Filed: May 12, 2025

(30) Foreign Application Priority Data
May 14, 2024 (GB) 2406843.9

(51) Int. Cl. G06T 19/00; G06V 10/764; G06V 20/20; G06V 20/52

(52) U.S. Cl. CPC G06T 19/006; G06V 10/764; G06V 20/20; G06V 20/52; G06V 2201/07

(57) ABSTRACT

A method for indicating real and virtual objects during display of a virtual environment on a virtual reality, VR, headset, the method comprising: obtaining real-time data derived from monitoring a real-world environment associated with the VR headset; obtaining virtual display data representing one or more virtual objects within the virtual environment; analysing at least one of the real-time data and virtual display data to identify at least one target object in the data; classifying the object type of the at least one target object, the object type being either a real object or a virtual object; providing to the user an indication of the object type of the at least one target object, during display of a virtual environment.

### FIELD OF THE INVENTION

The following disclosure relates to a method and system for indicating real and virtual objects and, in particular, a method and system for indicating real and virtual objects during display of a virtual environment on a virtual reality (VR) headset.

### BACKGROUND

Virtual Reality (VR) and Augmented Reality (AR) are often used to provide an immersive and interactive experience of a game to a user in order to enhance their gaming experience. Providing a VR experience includes display of a computer-simulated environment that simulates a user's presence in real or imaginary environments, without transparency to real-world visuals experienced by the user. AR similarly includes display of a computer-simulated environment to a user but additionally involves overlaying the virtual display content with real-world visuals to provide a mixed reality environment.

As computer and video game graphics improve, display of both VR and AR environments leave the user at risk of experiencing an uncanny valley effect. This effect refers to the unease of a user when environments, objects and/or characters in the environment look close to their real-life counterpart but have subtle differences. The uncanny valley effect can make a user uncomfortable, or even cause them to mistake virtual objects for a real objects. Consequently, the user may attempt to interact with virtual objects in the environment. For example, a user in an AR environment may mistake a virtual table for a real table and may attempt to place their real controller on the virtual table. Alternatively, the user may mistake a real table for a virtual table and may attempt to walk through it.

The mistaking of a virtual object for a real object, or vice versa, may result in the user feeling disorientated, or even in accident or injury. This disorientation can also detract from the immersive experience of the game by the user. Therefore, there is a need to mitigate these risks during the display of a virtual reality or augmented reality environment.

### SUMMARY

It is an object of the present disclosure to provide methods and systems which makes progress in solving some of the problems identified above.

According to a first aspect of the present disclosure, there is provided a method for indicating real and virtual objects during display of a virtual environment on a virtual reality, VR, headset, the method comprising: obtaining real-time data derived from monitoring a real-world environment associated with the VR headset; obtaining virtual display data representing one or more virtual objects within the virtual environment; analysing at least one of the real-time data and virtual display data to identify at least one target object in the data; classifying the object type of the at least one target object, the object type being either a real object or a virtual object; providing to the user an indication of the object type of the at least one target object, during display of a virtual environment.

A VR headset may refer to any wearable headset configured to display a virtual reality and/or an augmented reality environment to a user. The real-time data may comprise data obtained in real-time from monitoring, for example by detecting and/or tracking, one or more features of the surrounding environment in which the user wearing the VR headset is in. The real-time data may additionally or alternatively comprise data obtained in real-time from monitoring features of the VR headset relative to the user such as a user position, a head orientation, a gaze direction etc. A virtual object may be any object type, surface, texture and/or feature of an object in the virtual display data. A real object may refer to any object type, surface, texture and/or feature of an object in the real-time data.

In examples where the displayed virtual environment is displayed in accordance with a virtual reality experience, the virtual environment is rendered and displayed using the virtual display data, without combining or overlaying it with the real-time data. In other words, the displayed virtual environment only displays virtual objects and features to the user, without displaying real-world surroundings of the user. In some examples in which the displayed virtual environment is displayed in accordance with an augmented reality experience, the display of a virtual environment comprises combining the real-time data with the virtual display data to provide an overlay of at least a portion of virtual display data onto real-time data. The virtual display data may relate to a movie, a street-level tour and, preferably a video game, which is displayed to the user to simulate a user's presence in the virtual environment of said movie, tour or video game.

Providing to the user an indication of the object type of the at least one target object, during display of a virtual environment may comprise using any suitable visual, auditory or haptic signal as the indication of the object type. For example, a real object may be indicated by displaying the text “Real” proximal to the identified at least one target object in an example where the real-world data has been analysed to identify at least one target object as being real. Similarly, a virtual object may be indicated by displaying the text “Virtual” proximal to the identified at least one target object in an example where the virtual data has been analysed to identify at least one target object as being virtual.

By providing an indication of the object type of the at least one target object, it is indicated to the user whether the object is a virtual object (i.e. not real) or whether the object is a real object. In this way, the user can quickly differentiate a real object from a virtual object during display of the virtual environment. This alleviates any issues the user may experience relating to the uncanny valley effect and reduces the likelihood of a user mistaking a virtual object for a real object. As such, there is a reduced risk of physical harm and distress to the user during a virtual reality or augmented reality environment.

In some examples, the method further comprises determining an object position of the at least one target object within the virtual environment; and indicating the object type based on the object position. As such, an identified at least one target object with a given object position may be indicated to the user.

In some examples, providing the indication based on the determined distance of the user from the object position comprises indicating the at least one target object when the distance of the user to the object position is within a predetermined distance.

In other words, the user may be alerted to the at least one target object (via the indication) when their position in the virtual environment is close to or proximal to the at least one target object. This prevents overwhelming the user with many indications of various objects as only those objects which are most likely to be interacted with by the user (i.e. those proximal to the user) are indicated. In this way, the user can take the appropriate action to avoid physical harm and to prevent distress.

In some examples, the method further comprises obtaining a tracked object position by tracking the object position of the at least one target object; and updating the indication based on the tracked object position. In this way, the indication provided to the user is accurate and aligned with the current location of the at least one target object during display of the virtual environment. This further reduces the risk of physical harm and distress to the user during a virtual reality or augmented reality environment as the user is provided with an indication aligned with a real-time location of the at least one target object.

In some examples, providing to the user an indication of the object type of the at least one target object during display of a virtual environment comprises only providing the indication when the at least one target object is classified as a virtual object or only providing the indication when the at least one target object is classified as a real object.

Advantageously, by only indicating when the at least one target object is real or only indicating when the at least one target object is virtual, a simple means for indicating the at least one target object may be provided. For example, it is not required that there be two differentiable indicators used to distinguish between a real and virtual object, but instead the user knows that when an indication is shown, it will only indicate the object is one of real or virtual. For example, an arrow may be used to indicate that the identified at least one target object is real, and no indication is used when the object is virtual.

In some examples, the indication of the object type of the at least one target object is based on a preset toggled state.

A toggle may refer to a feature of the display of the virtual environment which can be activated or deactivated by the user. The term preset toggled state refers to a state which has been determined based on a toggle chosen by the user prior to display of the virtual environment. In some examples, the preset toggled state may comprise an “on” state which refers to the indication being shown to the user during display of the virtual environment.

In other examples, the preset toggle state is one of two or more toggle states. The toggle states may comprise a “virtual” state which displays an indication only when the at least one target object is classified as a virtual object, and may further comprise a “real” state which displays an indication only when the at least one target object is classified as a real object. In other words, the user may use the toggle to select whether they want identified virtual objects to be indicated during display of the virtual environment or whether they want real objects to be indicated to them. Alternatively, the user may use the preset toggled state to select a state indicating both virtual and real objects during display of the virtual environment.

In some examples, providing to the user an indication of the object type of the at least one target object during display of a virtual environment comprises at least one of: displaying a marker at the object position; outputting an auditory signal; and outputting a haptic signal.

Displaying a marker at the object position may comprise displaying the marker proximal to the identified at least one target object. A marker refers to any suitable visual icon or text which may be shown during display of the virtual environment. Specific examples of the marker include an arrow pointing to the identified at least one target object, text reciting “Real” for a real object or text reciting “Virtual” for a virtual object. Using an audible or haptic signal to indicate an identified at least one target object may be advantageous when a user needs to be quickly alerted to the object. For example, if the user is attempting to sit on a virtual chair, a haptic signal output via a peripheral device can alert the user to become aware of the virtual chair thereby reduced risk of physical harm and distress to the user during a virtual reality or augmented reality environment.

In some examples, analysing at least one of the real-time data and virtual display data to identify at least one target object in the data further comprises deriving object information associated with the identified at least one object.

The object information refers to attributes of the identified at least one target object. In this way, more information about the object is known to the system which may subsequently be used to customise the indication to the user.

In some examples, the object information comprises one or more of: an object label; an object orientation; an object position; an object dimension; and an object material.

The object label may refer to a category of object, for example the category may be one of a dog, a cat, a table, a chair etc. The object label may be based on common features associated with that object. The object orientation may refer to a spatial orientation or the pose of the identified at least one target object within the virtual environment. The object dimension may include or can be used to deduce a size of the at least one target object.

In some examples, the indication of the object type of the at least one target object is further based on the object information.

By further basing the indication of the object type on the object information, the indication may provide additional information to the user about the identified target object. For example, in addition to indicating that the object is a real object or a virtual object, an object label may also be provided to the user. In a specific example where the identified target object is a real table, the indication may therefore not only indicate the object is real but may also indicate that the at least one identified target object is a real table. In this way, the user can use their common knowledge of these objects to decide how to interact with it in the virtual environment. For example, the user can quickly determine whether a “real table” is suitable for placing a peripheral controller on. As such, there is a reduced risk of physical harm and distress to the user during a virtual reality or augmented reality environment.

In some examples, a machine learning algorithm is used for at least one of: analysing at least one of the real-time data and virtual display data to identify at least one target object in the data; and classifying the object type of the at least one target object, the object type being either a real object or a virtual object.

Machine learning is an efficient and effective way of executing object identification. Therefore, the reliability of the identifying the at least one target object in the data is improved and the speed at which the at least one target object is identified may also be improved.

In some examples, obtaining real-time data derived from monitoring a real-world environment associated with the VR headset comprises obtaining at least one of: video data of the environment; and sensor data of the environment.

According to a second aspect of the present disclosure, there is provided a system for indicating real and virtual objects during display of a virtual environment on a virtual reality, VR, headset, the system comprising: a real-world data obtaining module configured to obtain real-time data derived from monitoring a real-world environment associated with the VR headset; a virtual display data obtaining module configured to obtain virtual display data representing one or more virtual objects within the virtual environment; an analysing module configured to obtain at least one of the real-time data and virtual display data to identify at least one target object in the data; a classifying module configured to classify the object type of the at least one target object, the object type being either a real object or a virtual object; an indication module configured to provide to the user an indication of the object type of the at least one target object, during display of a virtual environment.

The above mentioned modules may be included in one or more processors. A VR console may comprise the one or more processors.

### BRIEF DESCRIPTION OF DRAWINGS

FIG. 1 illustrates a system in which a method according to the present disclosure may be implemented;

FIG. 2 is a flow chart schematically illustrating steps of a method according to the present disclosure;

FIG. 3 is a schematic diagram of an exemplary display of a virtual environment according to the present disclosure;

FIG. 4a is a schematic diagram of an exemplary display of a virtual environment according to the present disclosure;

FIG. 4b is a schematic diagram of an exemplary display of a virtual environment according to the present disclosure;

FIG. 4c is a schematic diagram of an exemplary display of a virtual environment according to the present disclosure.

### DETAILED DESCRIPTION

VR and AR experiences comprise displaying a virtual environment to a user to provide an immersive gaming experience. Consequently, the user is presented with visuals of virtual objects in the case of VR, or is presented with both virtual objects and real objects in the case of AR. However, the user may experience the uncanny valley effect as a result of the high quality gaming graphics. This may leave the user confused as to which objects in the virtual environment are real and which objects are virtual. Therefore, the following systems and methods are used for indicating real objects and/or virtual objects to the user during display of a virtual environment on a VR headset. In this way, the user is less likely to be confused as to which objects are real and which are virtual, reducing the uncanny valley effect experienced.

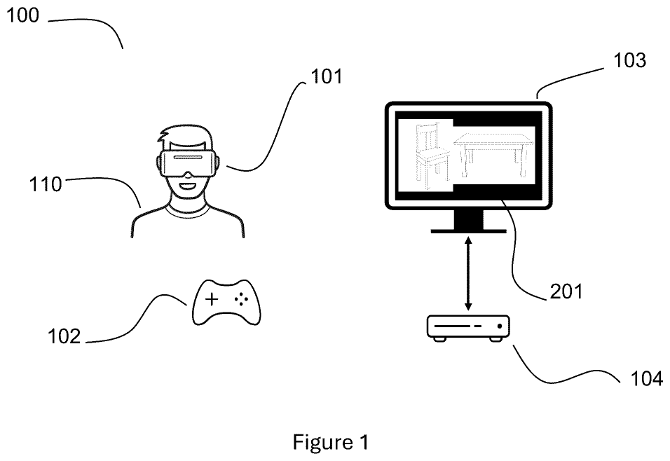

FIG. 1 illustrates a system 100 in which a method according to the present disclosure may be implemented.

In this example, the system 100 includes a head-mounted display 101, specifically a virtual reality (VR) headset 101 coupled to a VR console. The VR console comprises a computer 104 having at least one processor. The computer 104 may be a game console system, a personal computer, a laptop, a mobile device etc. In some examples, the VR console is configured to execute a video game and/or audio from the video game to be provided to the user 110 by the VR headset 101. The VR headset 101 and the VR console are coupled by a wired or wireless connection, alternatively the VR headset 101 and VR console may be the same device. Optionally, the system 100 can include a user interface, an audio generation device, a display device 103, and/or peripheral device such as a controller 102, a mouse, a keyboard or any other suitable device, and/or can be in communication with a smartphone or other devices.

In FIG. 1, a user 110 is shown wearing the VR headset 101. The VR headset 101 is worn in a similar manner to that of wearing glasses, goggles and is configured to present content to the user 110, such as a computer generated, 3-dimensional (3D) virtual environment represented by visual display content. VR applications include movies, street-level tours and, in particular, video games, which are displayed using display mechanisms in close proximity to the user's eyes in the VR headset 101. For example, a video game is provided by receiving and rendering the virtual display content of the game at a current point in time so as to display the virtual display content to a user 110 by the display mechanism 103.

The system 100 may comprise one or more sensors configured to obtain real-time data derived from monitoring a real-world environment associated with the VR headset 101. The VR headset 101 may include a head tracking sensor configured to obtain sensor data, in particular data relating to the orientation and position of the VR headset 101 relative to the surrounding environment. The sensors may further or alternatively include an inertial sensor including one or more of gyroscopes, accelerometers, and magnetometers. The system 100 may comprise one or more cameras configured to obtaining video data of the surrounding environment. In this way, the system may capture the user's surrounding environment allowing for analysis of the video data to identify at least one target object in the data.

In some examples, the system 100 additionally comprises eye-tracking sensors configured to monitor the user's eye movements. In this way, the displayed virtual environment may be rendered based on the gaze direction and/or eye movement of the user.

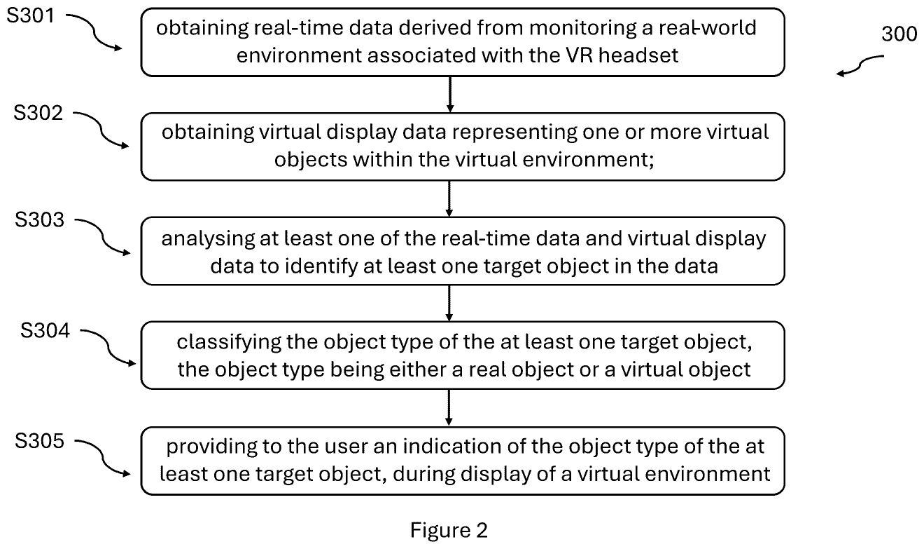

FIG. 2 shows a flow chart schematically illustrating steps of a method according to the present disclosure.

As described in S301 of FIG. 2, the method 300 comprises obtaining real-time data derived from monitoring a real-world environment associated with the VR headset 101. This may comprise obtaining video data and/or sensor data of the environment using cameras and sensors as described herein. To derive the real-time data, data obtained from cameras and/or sensors may be processed by the VR console so as to derive, for example, one or more of a user position, a user head orientation and at least one feature of the surrounding environment.

The method 300 comprises obtaining virtual display data representing one or more virtual objects within the virtual environment, as described in S302 of FIG. 2. The virtual display data may additionally comprise other features of the virtual environment such as characters, text, icons etc.

The method 300 comprises analysing at least one of the real-time data and virtual display data to identify at least one target object in the data, as described in S303 of FIG. 2. In some examples, analysing at least one of the real-time data and virtual display data to identify at least one target object in the data further comprises deriving object information associated with the identified at least one object. The object data may comprise one or more of an object label, an object orientation, an object position, an object dimension, and an object material. Once identified, the method 300 comprises classifying the object type of the at least one target object, the object type being either a real object or a virtual object, as described in S304 of FIG. 2.

The steps of analysing and classifying may comprise using a machine learning algorithm, such as a Convolutional Neural Network or other suitable models. For example, the model may be trained to recognise objects in image or sensor data using a labelled dataset such that when at least one of the real-time data and virtual display data is inputted into the model, the model can identify objects in this data.

The method 300 further comprises providing to the user an indication of the object type of the at least one target object, during display of a virtual environment, as described in S305 in FIG. 2. As such, the user 110 can quickly differentiate a real object from a virtual object by referring to the indication. This alleviates any issues with the uncanny valley effect and reduces the likelihood of a user mistaking a virtual object for a real object. As such, there is a reduced risk of physical harm and distress to the user during a virtual reality or augmented reality environment.

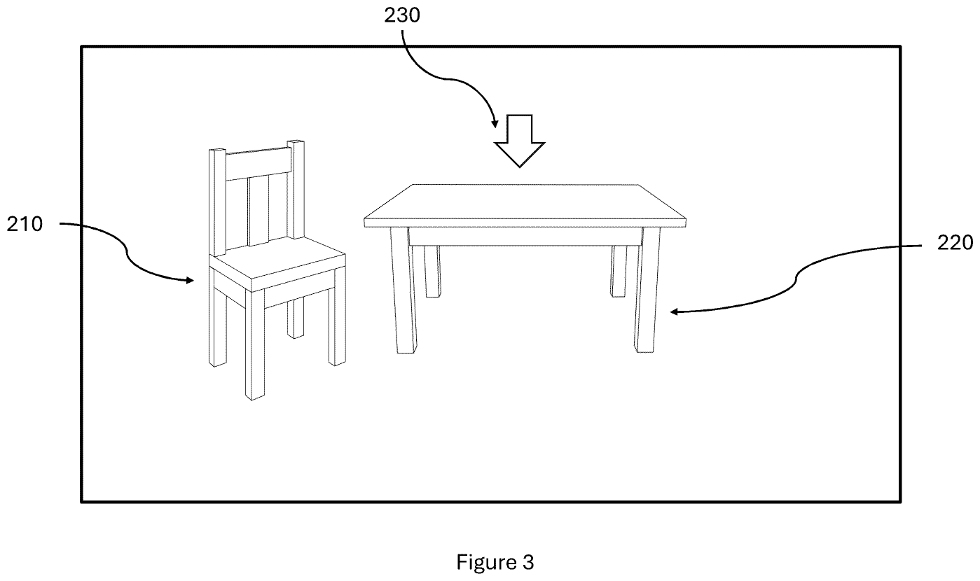

FIG. 3 is a schematic diagram of an exemplary display of a virtual environment according to the present disclosure. The virtual environment is shown from the view of the user 110 wearing the VR headset 101. In view is a chair 210 and a table 220, to which the user has no way of differentiating whether they are real or virtual objects during normal display of the virtual environment. This specific virtual environment is an augmented reality environment, wherein display of the augmented reality environment comprises overlaying virtual display content onto the real-world visuals. In this specific example, the chair 210 is a real-world object located in the surrounding environment of the user 110 while the table 220 is a virtual object represented in the virtual display data.

Settings related to the indication of the object type may have been selected by the user 110 prior to the display of the augmented reality environment. For example, the user 110 may have altered the settings of the VR console using a toggle. The user may use the toggle to select a preset toggled state which represents only providing an indication to the user 110 when the at least one target object is classified as a virtual object. In other examples, the user may select a preset toggle state which represents only providing the indication of the object type of the at least one target object to the user 110 when the at least one target object is classified as a real object.

In this example, the indication of the object type of the at least one target object is only provided to the user when the at least one target object is classified as a virtual object. Therefore, since the table 220 is a virtual object, an indication of this is provided to the user in the form of a virtual arrow 230 displayed proximal to the table 220. As shown, the real-world object in this example (i.e. the chair) does not have an indicator.

In other examples, an indication may be shown for both the chair 210 and the table 220. In such an example, two different indicators may be chosen such that the user 110 can distinguish between an indicator for a real object and an indicator for a virtual object. Moreover, in other examples, the indication of the object type of the at least one target object may only be provided to the user when the at least one target object is classified as a real object. Therefore, if this were the case in this specific example, the indicator 230, would be proximal to the chair 210 rather than the table 220.

As described above, the indication of the object type of the at least one target object in this example comprises displaying a marker at the object position. The marker is an arrow 230 pointing towards the target object being the table 230. However, other markers may be used to indicate the target object. Further, in some examples, the indication of the object type of the at least one target object additionally or instead comprises outputting an auditory signal and/or outputting a haptic signal.

Optionally, the method comprises determining an object position of the at least one target object within the virtual environment; and indicating the object type based on the object position. The method may comprise obtaining a tracked object position by tracking the object position of the at least one target object and updating the indication based on the tracked object position. As such, if the target object is a dynamic object such as a character or if the user is moving in the virtual environment relative to the target object, a tracked object position may be obtained.

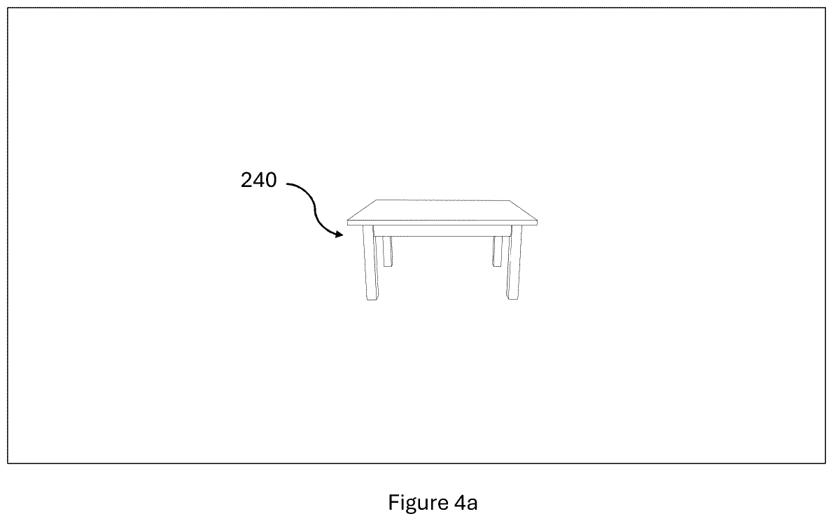

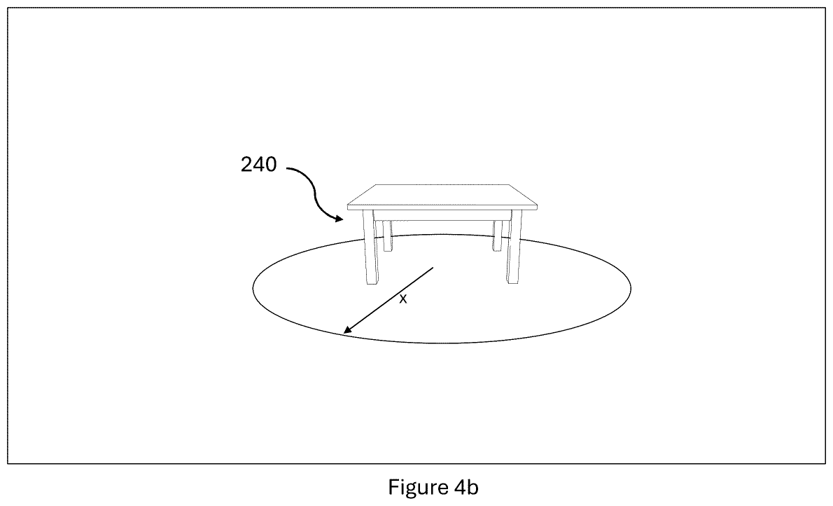

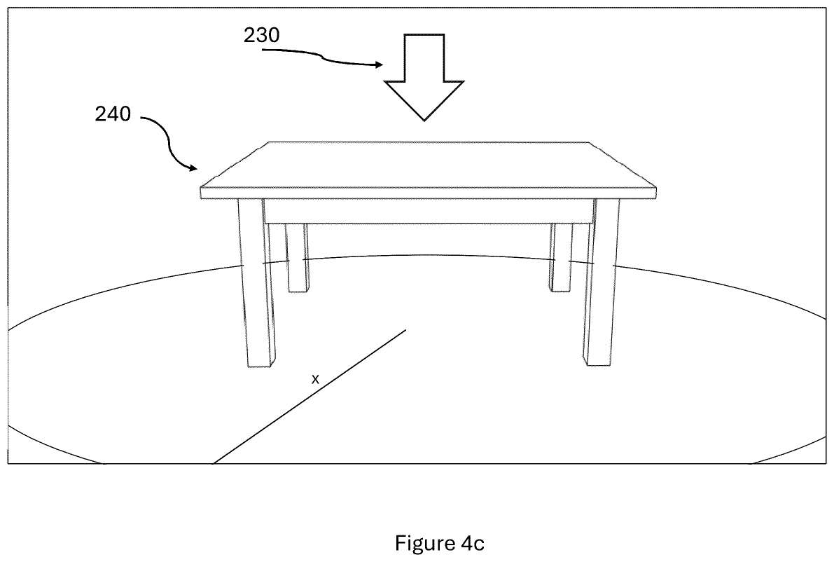

Moreover, in some examples, the method comprises providing the indication based on the determined distance of the user from the object position comprises indicating the at least one target object when the distance of the user to the object position is within a predetermined distance. FIGS. 4a-4c illustrate such an embodiment.

FIG. 4a is a schematic diagram of an exemplary display of a virtual environment according to the present disclosure. The virtual environment is shown from the view of the user 110 wearing the VR headset 101. FIG. 4b is a schematic diagram of the virtual environment of FIG. 4a, further provided with a visualisation of a predetermined distance x from the target object (which would not be displayed to the user 110). Distance x may be considered to radially project from the centre of the target object. If the user 110 is less than a distance x from the object in any direction, they will be within the predetermined distance such that an indication of the object type will be provided.

FIG. 4a shows a virtual object in a virtual environment, the virtual object being a table 240. The predetermined distance from the table 240 is set to distance x, as shown in FIG. 4b. Since the user is more than distance x from the table 240 in FIGS. 4a and 4b, there is no indication provided to the user since they are outside the predetermined distance.

However, FIG. 4c illustrates an updated display of a virtual environment as the user 110 has moved closer to the table 240. Once the distance of the user 110 to the object position is within a predetermined distance, the indication is provided to the user as shown. In this example, the indication is a virtual arrow 230 displayed to be pointing towards the table 240 so as to indicate to the user that the object type is virtual. If the user were to move away from the table 240, then the indication may disappear from view. In this way, the user is alerted to the presence of a virtual table 240 within their proximity such that they can take appropriate action to not be risk physical harm or negative interactions with the table.

1. A method for indicating real and virtual objects during display of a virtual environment on a virtual reality (“VR”) headset, the method comprising:
obtaining real-time data derived from monitoring a real-world environment associated with the VR headset;
obtaining virtual display data representing one or more virtual objects within the virtual environment;
analysing at least one of the real-time data and the virtual display data to identify at least one target object in any of the real-time data and the virtual display data;
classifying an object type of the at least one target object, the object type being either a real object or a virtual object;
providing to a user an indication of the object type of the at least one target object, during display of a virtual environment.

2. The method according to claim 1, further comprising:
determining an object position of the at least one target object within the virtual environment; and
indicating the object type based on the object position.

3. The method according to claim 2, further comprising:
determining a distance of the user to the object position within the virtual environment; and
providing the indication based on the determined distance of the user from the object position.

4. The method according to claim 3, wherein providing the indication based on the determined distance of the user from the object position comprises indicating the at least one target object when the distance of the user to the object position is within a predetermined distance.

5. The method according to claim 2, further comprising:
obtaining a tracked object position by tracking the object position of the at least one target object; and
updating the indication based on the tracked object position.

6. The method according to claim 1, wherein providing to the user an indication of the object type of the at least one target object during display of a virtual environment comprises only providing the indication when the at least one target object is classified as a virtual object or only providing the indication when the at least one target object is classified as a real object.

7. The method according to claim 1, wherein the indication of the object type of the at least one target object is based on a preset toggled state.

8. The method according to claim 1, wherein providing to the user an indication of the object type of the at least one target object during display of a virtual environment comprises at least one of:
displaying a marker at the object position;
outputting an auditory signal; or
outputting a haptic signal.

9. The method according to claim 1, wherein analysing at least one of the real-time data and the virtual display data to identify the at least one target object further comprises deriving object information associated with the identified at least one object.

10. The method according to claim 9, wherein the object information comprises one or more of:
an object label;
an object orientation;
an object position;
an object dimension; or
an object material.

11. The method according to claim 9, wherein the indication of the object type of the at least one target object is further based on the object information.

12. The method according to claim 1, wherein a machine learning algorithm is used for at least one of:
Analysing at least one of the real-time data and the virtual display data to identify the at least one target object; and
classifying the object type of the at least one target object, the object type being either a real object or a virtual object.

13. The method according to claim 1, wherein obtaining real-time data derived from monitoring a real-world environment associated with the VR headset comprises obtaining at least one of:
video data of the environment; and
sensor data of the environment.

14. A system for indicating real and virtual objects during display of a virtual environment on a virtual reality (“VR”) headset, the system comprising:
a real-world data obtaining module configured to obtain real-time data derived from monitoring a real-world environment associated with the VR headset;
a virtual display data obtaining module configured to obtain virtual display data representing one or more virtual objects within the virtual environment;
an analysing module configured to obtain at least one of the real-time data and virtual display data to identify at least one target object in any of the real-time data and the virtual display data;
a classifying module configured to classify an object type of the at least one target object, the object type being either a real object or a virtual object;
an indication module configured to provide to a user an indication of the object type of the at least one target object, during display of a virtual environment.
